(19) United States
(12) Patent Application Publication
(10) Pub. No.: US 2009/0130918 A1
(43) Pub. Date: May 21, 2009

(54) High Speed Backplane Connector

(75) Inventors: Hung Thai Nguyen, Harrisburg, PA (US); Richard P. Walter, Elizabethtown, PA (US); John A. Fulponi, Harrisburg, PA (US)

Correspondence Address: TYCO TECHNOLOGY RESOURCES, 4550 NEW LINDEN HILL ROAD, SUITE 140, WILMINGTON, DE, 19808-2952, US

(73) Assignee: Tyco Electronics Corporation, Middletown, PA (US)

(21) Appl. No.: 11/943,183

(22) Filed: Nov. 20, 2007

(51) Int. Cl. H01R 9/22

(52) U.S. Cl. 439/709

(57) ABSTRACT

A terminal module for assembly into a high speed electrical connector. The module includes an electrically insulated housing, a first contact portion and a second contact portion. The second contact portion is in electrical communication with the first contact portion via a contact interconnection. The contact interconnection is at least partially disposed within the insulated housing. At least one of the first contact portion or the second contact portion includes a contact selected from the group consisting of a mesh contact element, a socket configured to receive a mesh contact element and combinations thereof.

### FIELD OF THE INVENTION

The present disclosure is directed to electrical connectors. In particular, the disclosure is directed to high speed electrical connectors for connecting circuit boards for harsh vibration environment applications such as military and aero space.

### BACKGROUND OF THE INVENTION

Electronic equipment, such as that used in military applications, is often required to be operated in rugged, extreme environmental conditions. Examples of such conditions include excessive moisture, salt, heat, vibration, mechanical shock, and electromagnetic interference. To function cooperatively, some type of connector is required so that when two printed circuit boards are brought into electrical contact with one another, the boards function as a single board when inserted into a backplane board or other module of a larger electronic piece of equipment.

Other conventional connectors include a two piece connector using so-called flex circuits extending from the printed circuit boards. These flex circuits must be soldered to the printed circuit board. While the flex circuits may provide easier access for the soldering, problems with alignment still exist. In addition, the flex circuit has long tails that act like antennae, which tails create interference and limit performance as described above.

What is needed is a way to terminate a printed circuit board or other circuit for connecting to a backplane board that avoids problems in alignment and maintains a high speed electrical signal connection between printed circuit boards in rugged, extreme environmental conditions.

### SUMMARY OF THE INVENTION

A first aspect of the present disclosure includes a terminal module for assembly into a high speed electrical connector. The module includes an electrically insulated housing, a first contact portion and a second contact portion. The second contact portion is in electrical communication with the first contact portion via a contact interconnection. The contact interconnection is at least partially disposed within the insulated housing. At least one of the first contact portion or the second contact portion includes a contact selected from the group consisting of a mesh contact element, a socket configured to receive a mesh contact element and combinations thereof.

Another aspect of the present disclosure includes a high speed electrical connector. The electrical connector includes a printed circuit board, a backplane and a module. The terminal module includes an electrically insulated housing a first contact portion, the first contact portion being connectable to the printed circuit board. The module also includes a second contact portion in electrical communication with the first contact portion via a contact interconnection. The contact interconnection is at least partially disposed within the insulated housing. At least one of the first contact portion or the second contact portion includes a contact selected from the group consisting of a mesh contact element, a socket configured to receive a mesh contact element and combinations thereof.

An advantage of the present invention is that the mesh contact member provides alignment and signal continuity between printed circuit boards, particularly when exposed to rugged and/or extreme environmental conditions.

Another advantage of the present invention is that the mesh contact member can be formed with multitude of small wires and therefore low normal force between wire and socket providing an advantage of long-term fretting corrosion effects.

Another advantage of the present invention is that the mesh contact member can be soldered or welded at the tip therefore each wire is protected when misalignment of connector may otherwise cause damage to the contact interfaces as seen in many other designs.

Another advantage of the present invention is that the mesh contact portion can be protected by tightly controlled recessed cavity.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 shows a perspective view of a connector system according to an embodiment of the disclosure.

FIG. 2 shows an perspective view of a terminal module according to an embodiment of the disclosure.

FIG. 3 shows a perspective view of a mesh contact element according to an embodiment of the disclosure.

FIG. 4 shows a perspective view of a backplane according to an embodiment of the disclosure.

FIG. 5 shows a cutaway side view of a connector system according to an embodiment of the disclosure.

FIG. 6 shows a partially exploded view of a connector system according to an embodiment of the disclosure.

Wherever possible, the same reference numbers are used throughout the drawings to refer to the same or like parts.

### DETAILED DESCRIPTION OF THE INVENTION

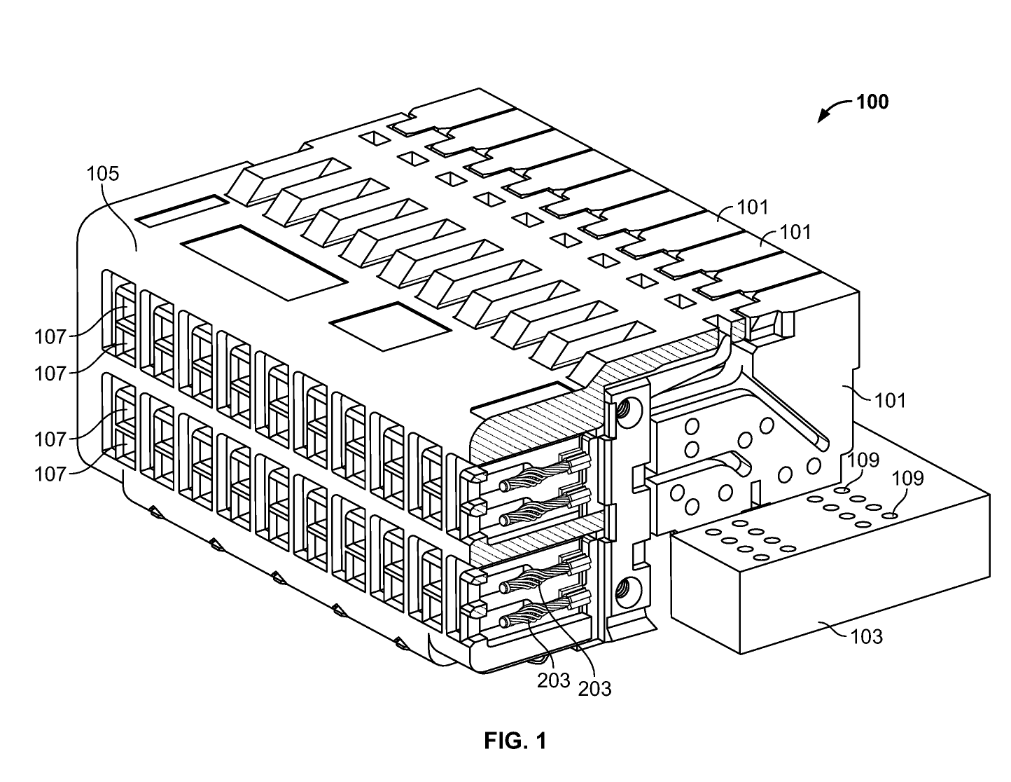

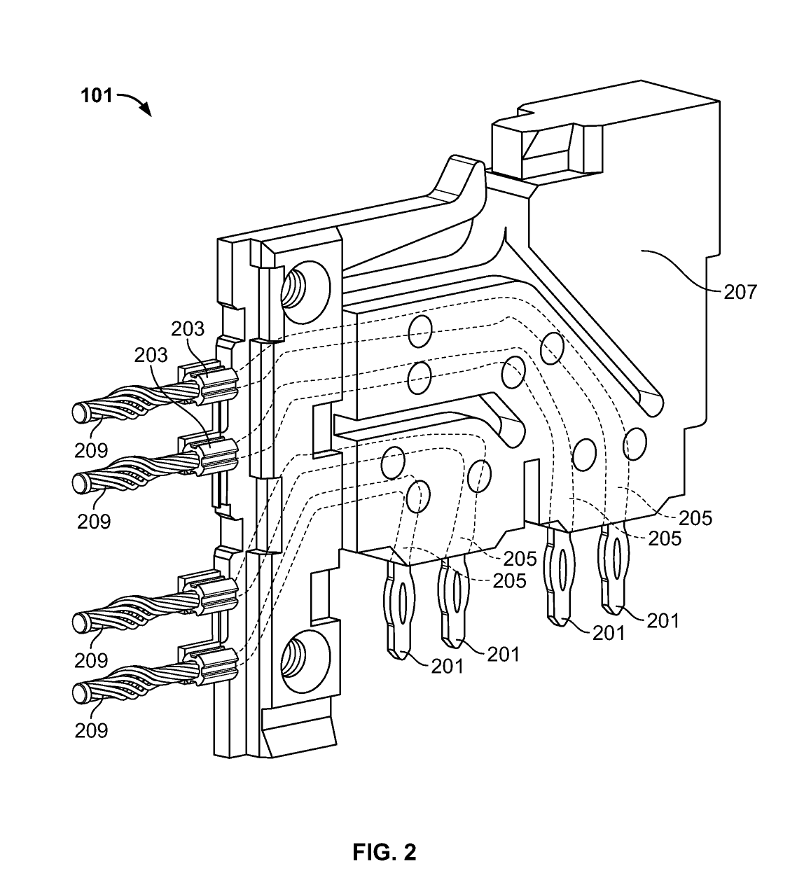

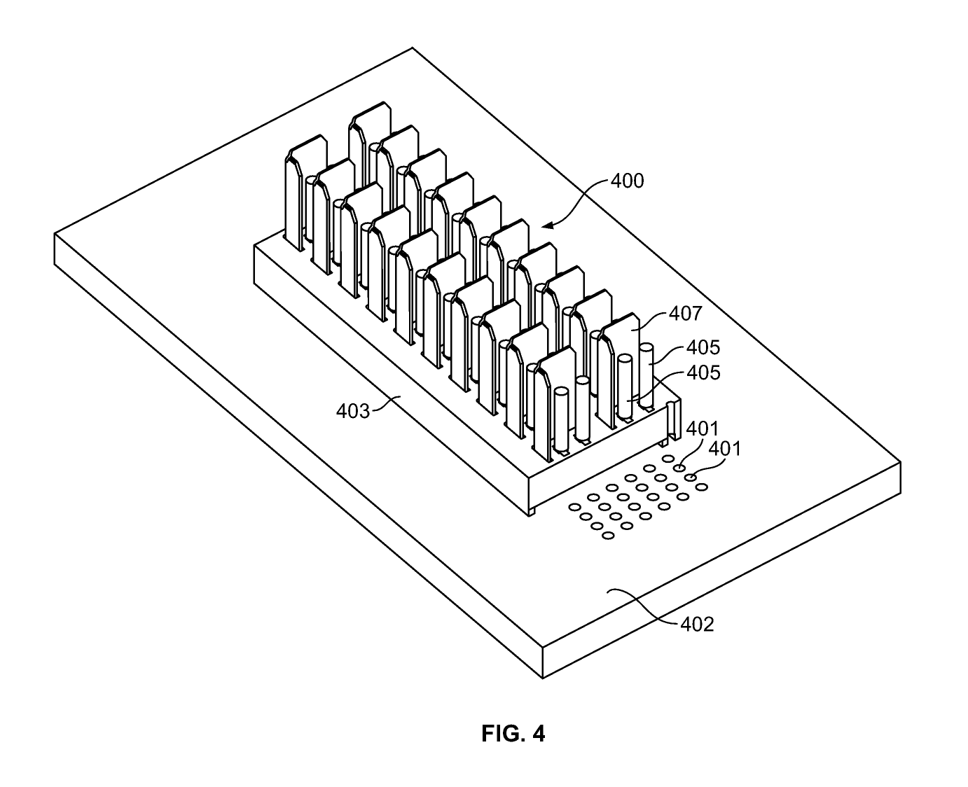

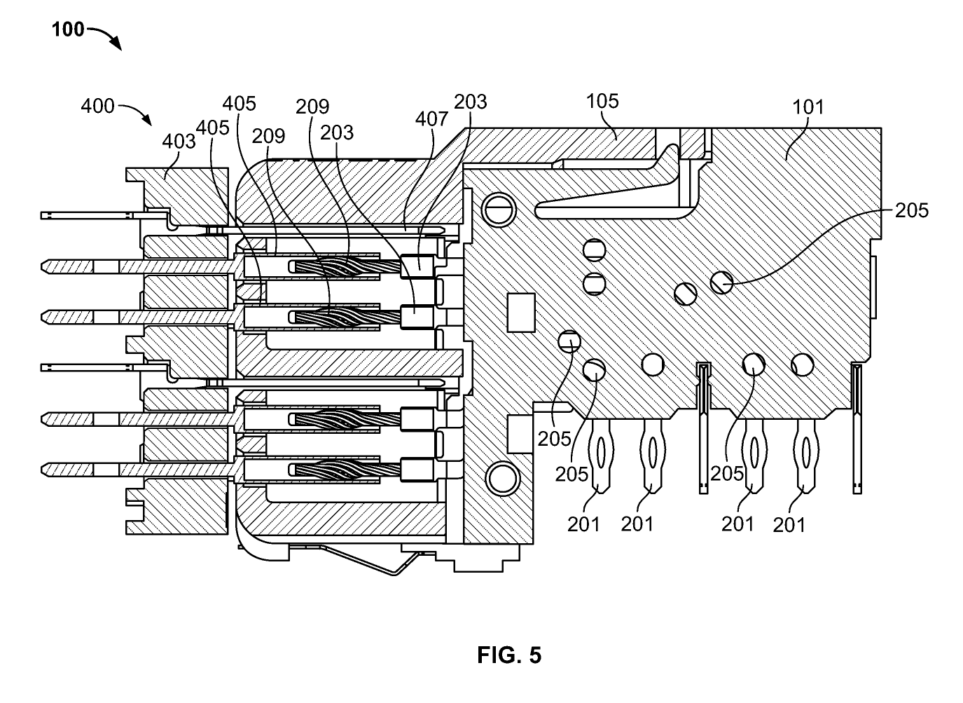

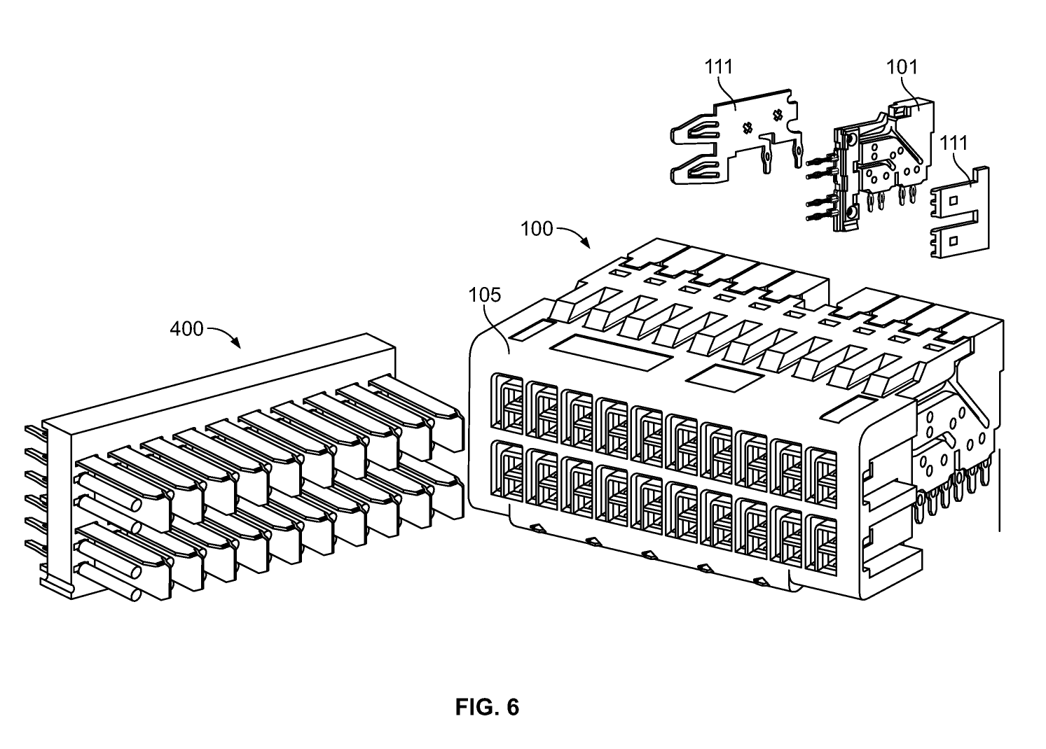

FIG. 1 shows a connector system 100 according to an embodiment of the disclosure including a plurality of terminal modules 101 connected to a printed circuit board (PCB) 103 and inserted into a terminal housing module 105. Housing module 105 includes a plurality of socket receiving apertures 107 configured to receive sockets of a backplane 400 (see e.g. FIGS. 4-5). The terminal modules 101 connect to the PCB 103 via first contact portion 201 (see e.g., FIG. 2) engaged with opening 109 in the PCB 103. The terminal modules 101 include second contact portions 203 (see also e.g., FIG. 2) for connecting to a backplane 400 (see e.g., FIGS. 4-5). Shielding members 111 are configured and disposed adjacent terminal modules 101 to provide shielding for the second contact portions 201 (see e.g., FIG. 6). Shielding members 111 or similar structures may be utilized to shield the signal contacts from EMI/RFI.

FIG. 2 shows a perspective view of a terminal module 101 according to an embodiment of the disclosure. The terminal module 101 includes a plurality of first contact portions 201 and a plurality of second contact portions 203. The first contact portion 201 and second contact portion 203 are electrically connected via a contact interconnection 205. While FIG. 2 shows sets of four first contact portions 201, second contact portions 203 and contact interconnections 205, the invention is not so limited and may include any number of sets of first contact portions 201, second contact portions 203 and contact interconnections 205, including greater than sets of four or less than sets of four. In one embodiment, the first contact portion 201 and the second contact portion 203 are perpendicularly disposed. The contact interconnections 205 are partially disposed within an insulated housing 207. The insulated housing 207 provides insulation, placement and spacing of the modules 101 within the connection system 100. The first contact portion 201 is configured to connect with openings 109 formed in PCB 103. Suitable configurations for the first contact portion 201 include, but are not limited to, compliant pins that engage openings 109 and provide electrical connectivity.

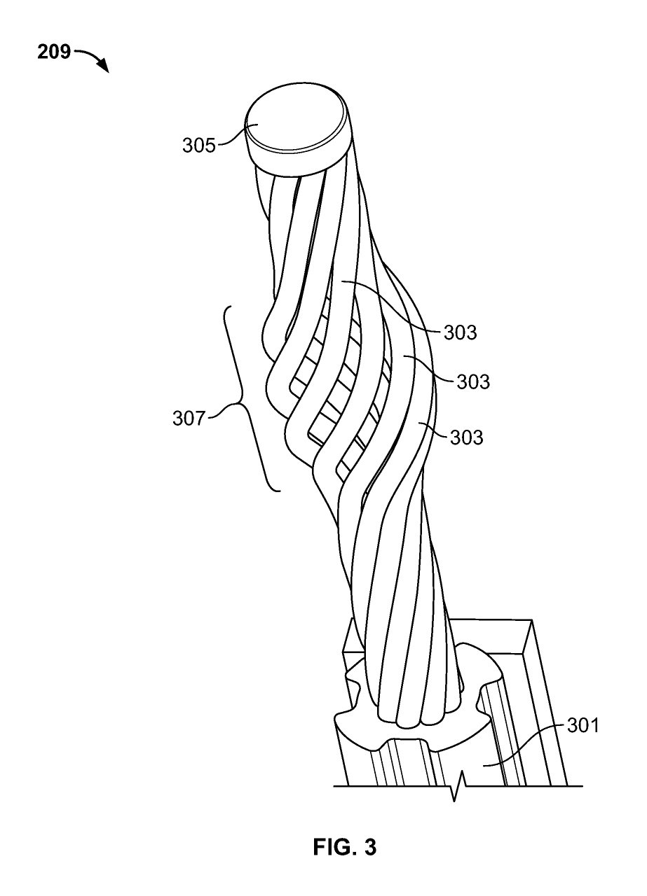

The second contact portion 203 includes a mesh contact element 209 having a mesh bulb or bulbous portion 307 (see FIG. 3) formed from electrically conductive material. The mesh contact element 209 includes a woven or non-woven mesh of conductive wire leads 303 (see FIG. 3). Although the second contact portion is shown as including a mesh contact portion 209, the second contact portion 203 may including a contact selected from the group consisting of a mesh contact element 209, a socket configured to receive a mesh contact element 209 and combinations thereof. The second contact portion 203 may be formed integrally with the contact interconnection 205 and first contact member 201 or may be connected to the contact interconnection 205 via any known connection method. The second contact portion 203 can be a separate connection with suitable conductive material for any kind of attachment of the wire mesh 209 and the contact interconnection 205. The second contact portion 203 may be embedded within the housing 207 for increased mechanical stability and improved electrical performance for the connector.

FIG. 3 shows a mesh contact element 209 according to an embodiment of the present disclosure. The mesh contact element 209 includes a base 301 configured integrally with the contact interconnection 205 and first contact portion 201 or connectable to the contact interconnection 205. Wire leads 303 extend from the base 301 and form a bulbous geometry. The wire leads 303 are fabricated from an electrically conductive wire material, which is bent or oriented into a woven or non-woven structure. The wire leads 303 terminate at a tip 305, which provides a reduced diameter and termination/consolidation of the wire leads 303 suitable for insertion into a socket or similar receptacle. The bulbous portion 307 of the mesh contact element 209 is elastically deformable and provides a plurality of contact points between the wire leads 303 and the socket or receptacle. The deformation may be from bending or deflecting of the wire leads 303 or deflection of the bulbous portion 307 due to the weave or pattern of the wire leads 303. The contact with bulbous portion 307 is substantially uniformly distributed at multiple contact points along the periphery inside of the engaged socket or receptacle, providing resistance to vibration, jarring, movement or other environmental conditions that may occur, particularly when utilized in vehicles operating in rugged and/or extreme environments. Furthermore, low normal force of individual wire 303 reduces fretting corrosion effect and therefore improve long term connector life. While not so limited, the second contact portion 203, if it is an integral part of contact portion 205, can be stamped at the same time as portion 205 is made, or if it is a separate piece the second contact portion 203 can be extruded or machined or drawn.

The first contact portion 201, the second contact portion 203 and the contact interconnections 205 may be formed in part or in whole of an electrically conductive material or coating in part or in whole with an electrically conductive material so as to provide an electrical connection to the PCB 103. For example, the electrically conductive components may be formed of a phosphor bronze metal or hard copper alloy with tin plating or other known industry acceptable conductive metal and/or plating combinations

With reference now to FIG. 4, a backplane 400 is shown as including a plurality of through hole portions 401 through circuit board 402. Circuit board 402 may be any arrangement of circuit board, including printed circuit boards, configurable to include backplane 400. Backplane 400 includes a post header 403 electrically interconnected to the through hole portions 401 and circuit board 402. The post header 403 further includes a plurality of socket posts 405 where the socket posts 405 are configured as hollow cylinders or similar geometry capable of receiving and electrically communicating with the mesh contact member 209. The socket posts 405 extend through the post headers 403 and into the hole portion 401 of circuit board 402. The socket posts 405 may be individually unitary components or may be a plurality of components connected to each other (i.e., collective unitary construction). For example, the socket posts 405 may include cylindrical geometries extending from the post header 403 and a pin-like geometry extending into or through the circuit board 402. The post header 403 may further include keying features or similar structures known in the art to provide alignment, keying and/or stability while components are engaged. In addition, shielding members 407 or similar structures may be utilized to shield the signal contacts from EMI/RFI and may include any structures known in the art for providing electrical shielding. In the embodiment shown in FIG. 4, the shielding members 407 are insertable into the socket receiving apertures 107 to provide shielding.

FIG. 5 shows a cutaway side view of a connector system 100 according to an embodiment of the disclosure. As discussed above, the second contact portions 203, including the mesh contact members 209 are insertable and engagable with the cylindrical socket posts 405 of the backplane 400. Although the above has been described with respect to cylindrical socket posts 405, the socket posts 405 may include alternate annular geometries, including but not limited to annular conduits having an oval, square, rectangular or other cross-section configured to receive mesh contact member 209 and engage and electrically communicate with the mesh contact member 209 along the periphery of the interior of the socket post 405. To connect the backplane 400 to the connector system 100, the backplane 400 and the connector system 100 are directed toward each other, wherein the socket posts 405 are inserted into the socket receiving apertures 107 (see FIG. 1), wherein the mesh contact members 209 are deflected or deformed sufficiently to permit insertion and retain physical contact and electrical connectivity within socket post 405. The mesh contact member 209 contacts the socket posts 405 at multiple positions along the periphery of the cylindrical socket, providing a robust and continuous electrical communication therebetween. In addition, the mesh contact members 209 resist or prevent unintentional disengagement from the socket posts 405 even during exposure to rugged or extreme environments.

FIG. 6 shows a partially exploded view of a connector system 100 and backplane 400 according to an embodiment of the disclosure. As shown, the connector system 100 includes the terminal modules 101 arranged within the terminal housing 105, as shown and described above with respect to FIG. 1. In addition, in this embodiment, cross-talk shielding members 111 are provided and disposed between adjacent modules 101 to resist or prevent cross-talk between modules 101. The cross-talk shielding members 111 may be utilized to shield the signal contacts from signals within adjacent modules 101 and may include any structures known in the art for providing electrical shielding.

The present invention is not limited to the arrangement of connector system 100 and backplane 400 shown and described above. The connector system 100 and backplane 400 may be arranged perpendicularly, in parallel or at any angle or orientation to each other. The modules 101 may be fabricated such that the first and second contact portions 201, 203 are at varying angles to each other to provide connectivity at corresponding angles between circuit boards.

In another embodiment mesh contact element 209 can be arranged and disposed on the backplane 400, and the second contact portion 203 may include socket post 405. In this embodiment, the socket post 405 may be directed or otherwise brought into contact with the mesh contact element 209, wherein the mesh contact element 209 and socket post 405 are engaged. Although the second contact portion is shown as including a mesh contact portion 209, the second contact portion 203 may including a contact selected from the group consisting of a mesh contact element 209, a socket configured to receive a mesh contact element 209 and combinations thereof.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A terminal module for assembly into a high speed electrical connector, the module comprising:
an electrically insulated housing;
a first contact portion;
a second contact portion in electrical communication with the first contact portion via a contact interconnection, the contact interconnection being at least partially disposed within the insulated housing; and
wherein at least one of the first contact portion or the second contact portion comprises a mesh contact element including an elastically deformable bulbous portion having a plurality of contact points, the mesh contact element configured for establishing a vibration-resistant electrical connection.

2. The module of claim 1, wherein the module comprises a plurality of first contact portions, second contact portions and contact interconnections therebetween.

3. The module of claim 1, wherein the first contact portion is disposed perpendicularly to the second contact portion.

4. The module of claim 1, wherein the first contact portion, the second contact portion and the contact interconnections are a unitary component.

5. The module of claim 1, wherein the second contact portion is connected to the contact interconnection.

6. The module of claim 1, further comprising a cylindrical socket disposed on a backplane configured to receive the mesh contact element.

7. The module of claim 6, wherein the backplane includes a plurality of cylindrical sockets corresponding to a plurality of the second contact portions.

8. The module of claim 1, wherein the mesh contact element includes a bulbous woven geometry.

9. The module of claim 1, wherein the mesh contact element includes a bulbous non-woven geometry.

10. A high speed electrical connector comprising:
a printed circuit board;
a backplane;
a terminal module comprising:
an electrically insulated housing;
a first contact portion, the first contact portion being connectable to the printed circuit board;
a second contact portion in electrical communication with the first contact portion via a contact interconnection, the contact interconnection being at least partially disposed within the insulated housing; and
wherein at least one of the first contact portion or the second contact portion comprises a mesh contact element including an elastically deformable bulbous portion having a plurality of contact points, the mesh contact element configured for establishing a vibration-resistant electrical connection.

11. The system of claim 10, wherein the module comprises a plurality of first contact portions, second contact portions and contact interconnections.

12. The system of claim 10, wherein the first contact portion is disposed perpendicularly to the second contact portion.

13. The system of claim 10, wherein the first contact portion, the second contact portion and the contact interconnections are a unitary component.

14. The system of claim 10, wherein the second contact portion is connected to the contact interconnection.

15. The system of claim 10, further comprising a cylindrical socket disposed on a backplane configured to receive the mesh contact element.

16. The system of claim 15, wherein the backplane includes a plurality of cylindrical sockets corresponding to a plurality of the second contact portions.

17. The system of claim 10, wherein the mesh contact element includes a bulbous woven geometry.

18. The system of claim 10, wherein the mesh contact element includes a bulbous non-woven geometry.

19. The system of claim 15, further comprising a housing module having a plurality of socket receiving apertures configured to receive the cylindrical sockets.

20. The system of claim 15, further comprising a circuit board in electrical communication with the cylindrical socket.
